(19) United States
(12) Patent Application Publication
(10) Pub. No.: US 2003/0059292 A1
(43) Pub. Date: Mar. 27, 2003

(54) Water and gravity driven turbine systems and methods

(76) Inventor: James H. Baker, Marietta, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 09/965,388

(22) Filed: Sep. 27, 2001

(51) Int. Cl. F03B 1/02

(52) U.S. Cl. 415/3.1; 415/202

(57) ABSTRACT

An energy-converting apparatus is provided, which is capable of converting water current energy into usable energy. The apparatus is typically submerged in a body of water, where at least some of the water is moving as a water current. The apparatus includes at least one energy-converting module that is pressurized at a pre-determined internal pressure sufficient to offset the external pressure of the body of water in which the energy-converting module is submerged. In addition, the energy-converting module includes at least one turbine, at least one exit port, and at least one intake system. The intake system includes an entrance end and an exit end, where the water flowing in the water current enters the entrance end of the intake system. Thereafter, the water is accelerated as the water travels from the entrance end to the exit end of the intake system. The exit end directs the accelerated water onto an extension of the turbine causing the turbine to rotate and produce mechanical energy. Subsequently, the mechanical energy produced is derived from the kinetic energy of the water.

### TECHNICAL FIELD

The present invention is generally related to converting the natural energy of water currents and gravity into usable energy and, more particularly, is related to methods and apparatus for converting water current and gravity energy into usable energy using a submerged energy converting apparatus.

### BACKGROUND OF THE INVENTION

Rivers, lakes, and oceans have water currents that occur as a result of the gravitational pull of the moon, wind, temperature variation, etc. For centuries man has harnessed the energy of flowing waters. The oldest known apparatus for using water energy is the waterwheel. Various types of waterwheels have been used to drive sawmills, pumps, tilt-hammers, and trip-hammers as well as to power textile mills. Another apparatus for using water energy is the hydroelectric dam. Hydroelectric dams operate by blocking water flow and creating a reservoir of potential water energy. Generally, on the upper side of the dam, a water gate is opened to let water surge through a tunnel leading to one or more turbines. The water turns the turbines, which generate electricity.

A vast amount of water energy is stored in the world's oceans. Waves and tidal changes can be used to generate energy. Waves occurring at the beach or ocean swells can be used advantageously to produce energy. Generally, the waves can be used to turn turbines to produce energy. Likewise, a large amount of energy is stored in the tides. The tides move in and out in a predictable pattern. Tidal power stations can stretch over a delta, estuaries, beaches, or other places that are affected by the tides to capture water energy. Tidal currents can be used to turn turbines and produce energy therefrom. Furthermore, water currents off the coast (e.g., deep water currents) can be used to produce energy.

Many devices have been designed to capture water energy, but many have been unsuccessful due to design problems as well as being economically unsound. Thus, a need exists in the industry to economically harness water energy.

### SUMMARY OF THE INVENTION

Briefly described, the present invention provides an energy-converting apparatus. The apparatus is typically submerged in a body of water, where at least some of the water is moving as a water current. The apparatus includes at least one energy-converting module that is pressurized at a pre-determined internal pressure sufficient to offset the external pressure of the body of water in which the energy-converting module is submerged. In addition, the energy-converting module includes at least one turbine, at least one exit port, and at least one intake system. The intake system includes an entrance end and an exit end, where the water flowing in the water current enters the entrance end of the intake system. Thereafter, the water is accelerated as the water travels from the entrance end to the exit end of the intake system. The exit end directs the accelerated water onto an extension of the turbine causing the turbine to rotate and produce mechanical energy. Subsequently, the mechanical energy produced is derived from the kinetic energy of the water.

The present invention also involves methods of converting water current energy into usable energy. The steps involved include: accepting water into a first intake system, accelerating the water using the first intake system, directing the water from the first intake system onto a first turbine causing the first turbine to rotate, and producing mechanical energy.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a schematic of a representative example of the present invention representing an embodiment of the energy-converting apparatus.

FIG. 2 is a flow diagram illustrating an example of the representative operation of the embodiment depicted in FIG. 1.

FIG. 3 is a schematic of a representative example of another embodiment of the present invention representing the energy-converting apparatus having only one intake system for multiple energy-converting modules.

FIG. 4 is a flow diagram illustrating an example of the representative operation of the embodiment depicted in FIG. 3.

### DETAILED DESCRIPTION OF THE PREFERRED EMBODIMENT

The present invention includes apparatus and methods that are adapted to convert water energy (e.g., the kinetic energy of the water) into mechanical energy. The present invention is adapted to use water current energy by intaking the water and accelerating the water using an intake system. The accelerated water is then directed onto the extensions of a turbine. The impinging water causes the turbine to turn and consequently produce mechanical energy. Other embodiments of the present invention use gravity to accelerate the water, which subsequently impinges upon the extensions of the turbine causing the turbine to rotate, where the movement of the turbine produces mechanical energy. Further embodiments take advantage of both the energy derived from the water current and gravity to produce mechanical energy.

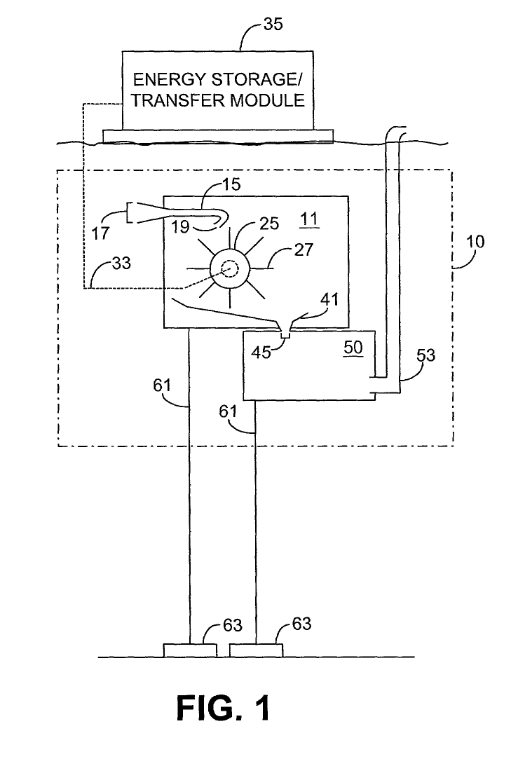

Referring now in more detail to the drawings, where like reference numerals designate corresponding parts through the views, FIG. 1 depicts a schematic of an example of the present invention representing an embodiment of the energy-converting apparatus 10. The energy converting apparatus 10 includes an energy converting module 11 and a pumping module 50. The energy converting module 11 includes at least one intake system 15, at least one turbine 25, and at least one exit port 41.

The intake system 15 (e.g. penstock system) includes an entrance end 17 and an exit end 19. Preferably, the intake system 15 is a Venturi intake system. In this regard, the water of the water current enters the Venturi intake system via the entrance end 17. The water flows through the narrowing pipes of the Venturi intake system and is accelerated. The water exits the Venturi intake system at the exit end 19 and upon exiting the Venturi intake system, the water impinges upon the turbine 25. In some embodiments, a pump (e.g. mechanical pump) may be used to initiate and/or assist the flow of water through the intake system. One or more pumps (not shown) may be used with the intake system 15 and/or the pumping module 50.

The turbine 25 includes one or more extensions 27 such as, for example, a vane, a blade, or other extension that functions to harness the energy of the water as the water contacts the extension 27. Representative turbines 25 include, for example, a Kaplan type wheel and a Pelton type wheel. However, one skilled in the art would understand that other types of turbines 25 can be used with embodiments of the present invention. The extensions 27 harness the kinetic energy of the water by rotating the turbine 25 as a result of the water impinging upon the extension 27. The rotation of the turbine 25 converts the kinetic energy of the water into mechanical energy. The mechanical energy can be converted into an alternative energy type such as electricity, using, for example, a powerhouse generator, drive shaft, hydropower generator, etc. The mechanical energy or alternative energy type can be subsequently transferred via link 33 to an energy storage/transfer module 35. The mechanical energy can be used to produce electricity or be used in other ways. The link 33 can be any device known in the art capable of transferring mechanical energy such as links used in the hydroelectric industry.

Generally, the energy storage/transfer module 35 can be located on the surface of the body of water, under water, or on land. The energy storage/transfer module 35 includes equipment (e.g. hydroelectric generator, hydroelectric magnetic systems, transformer, etc.) necessary to convert the mechanical energy into the energy of choice, such as, for example, electrical energy. In addition, the energy storage/transfer module 35 may include water purification equipment and manufacturing equipment, both of which can use the produced energy from the energy conversion module 10.

After the water causes the turbine 25 to rotate, the water travels out of the energy-converting module 11 via the exit end 45 of the exit port 41 and into the pumping module 50. The water may be pumped out of the pumping module 50 through the pumping exit 53. The water may be pumped to the surface or to any other appropriate depth.

The intake system 15 can use the produced mechanical energy derived from the water to operate. Similarly, the pumping module 50 can use some of the produced mechanical energy to operate the pumps and other components.

The energy-converting module 11 and the pumping module 50 can be secured to the bottom of the body of water using anchoring cable 61 and an anchoring device 63. Alternatively, the energy converting module 11 and the pumping module 50 can be held at various depths using appropriate flotation devices.

The energy-converting apparatus 10 is capable of withstanding the water pressure caused by the body of water. In this regard, the energy-converting apparatus 10 can be pressured and/or structurally built to accommodate the water pressure caused by the body of water.

The pumping modules 50 include standard water pumps. Other equipment that may be included in the pumping modules 50 include, for example, water conversion and general manufacturing equipment and electrical power plant equipment.

The mechanical energy produced by the turbines 25 can be converted to electrical energy via the energy storage transfer module 35 which may include, for example, general hydroelectric storage equipment such as a hydroelectric generator, transformer, etc.

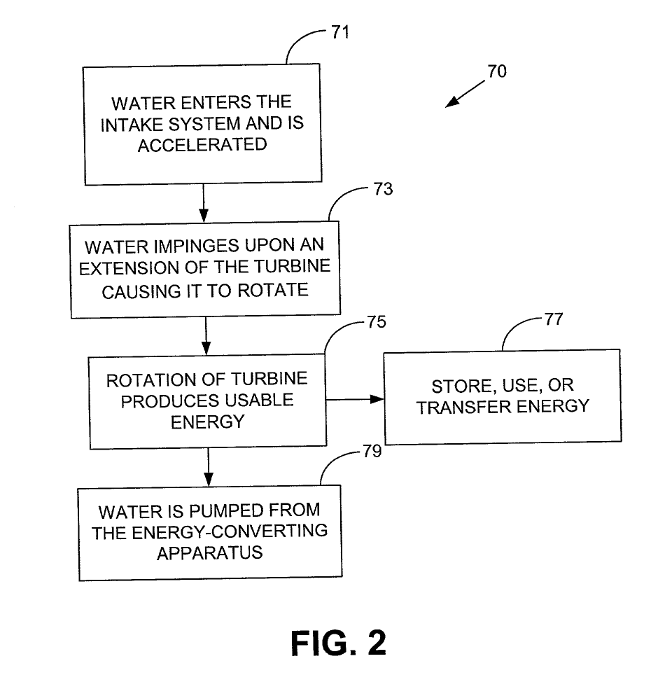

FIG. 2 is a flow diagram illustrating an energy-converting method 70 that is an example of the representative operation of the embodiment depicted in FIG. 1. Initially, water from the water current enters the intake system 15 and is accelerated, as shown in step 71. The water impinges upon the extension 27 of the turbine 25, which causes the turbine 25 to rotate, as shown in step 73. The rotation of the turbine 25 produces usable mechanical energy from the kinetic energy of the water, as shown in step 75. The mechanical energy derived from the water is related to the velocity of the water current and acceleration of water due to traveling through the intake system 15. Step 75 diverges into two directions, step 77 and step 79. Step 77 indicates that the mechanical energy produced from the kinetic energy of the water can be stored, transferred, or used. Step 79 indicates that the water exits the energy-converting apparatus 10 via the pumping module 50.

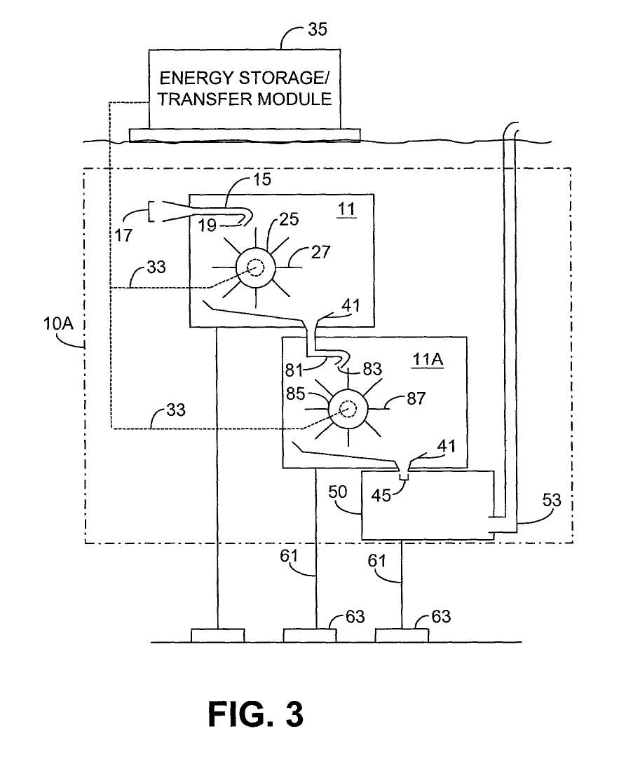

FIG. 3 is a schematic a representative example of another embodiment of the present invention representing the energy-converting apparatus 10A having only one intake system 15 for multiple energy-converting modules. This embodiment depicts two dependent energy-converting modules 11 and 11A and a pumping module 50. Each of the energy-converting modules 11 and 11A include at least one turbine 25 and 85 and at least one exit port 41. The energy-converting module 11 located at the highest water depth includes at least one intake system 15. Similar to the energy converting module in FIG. 1, the intake system 15 includes an entrance end 17 and an exit end 19. The water of the water current enters the intake system 15 via the entrance end 17. The water flows through the intake system 15 and is accelerated. The water exits the intake system 15 at the exit end 19 and upon exiting the intake system 15, the water impinges upon an extension 27 of a turbine 25. The rotation of the turbine converts the kinetic energy of the water into mechanical energy that can be transferred via link 33 to an energy storage/transfer module 35.

After impinging upon the extension 27 of the turbine 25, the water is channeled out of the energy-converting module 11 via the exit port 41 and into a lower energy-converting module 11A through a water transfer system 81. Gravity causes the water to flow out of the exit port 41 through the water transfer system 81 and out the exit 83 of the water transfer system 81. As the water flows through the water transfer system 81 it impinges upon an extension 87 of the turbine 85 of the second energy-converting module 11 A. The impinging water causes the turbine 85 to rotate and produce mechanical energy. Thereafter, the water can descend from one energy-converting device to another to produce mechanical energy upon each dissension, where acceleration of the water is caused by gravity. Subsequently, the water travels out of the energy-converting module 11A via the exit end 45 of the exit port 41 and into the pumping module 50. The water is pumped out of the pumping module 50 through the pumping exit 53 in a manner the same as or similar to the pumping module 50 discussed with reference to FIG. 1.

In an alternative embodiment, energy-converting module 11A can include an intake system (not shown). Having an intake system for energy-converting system 11A can produce additional mechanical energy. Therefore, the water from the intake system of energy-converting system 11A and the water from energy-converting module 11 can cause the turbine 85 to rotate to produce energy.

The energy-converting modules 11 and 11A and the pumping module 50 can be secured to the bottom of the body of water using anchoring cable 61 and anchoring device 63, such as those discussed with reference to FIG. 1.

Like the previous embodiment, the intake system 15 can use some of the produced mechanical energy to operate or the intake system 15 can use alternate energy sources. Similarly, the pumping module 50 can use some of the produced mechanical energy to operate the pumps or the pumping module 50 can use alternate energy sources.

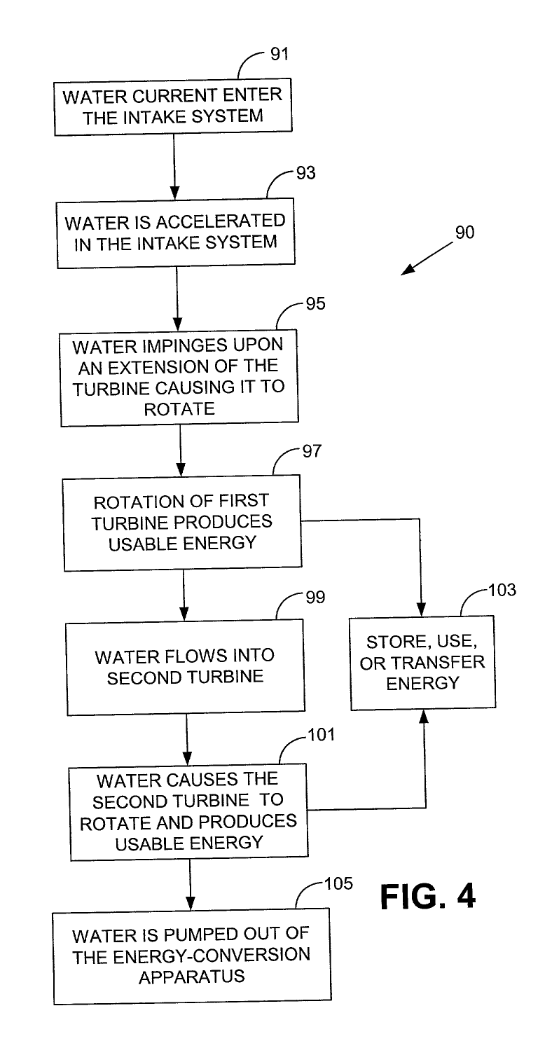

FIG. 4 is a flow diagram illustrating an energy-converting method 90 that is an example of the representative operation of the embodiment depicted in FIG. 3. Initially, water from the water flow enters the intake system 15 and is accelerated, as shown in steps 91 and 93. The water impinges upon an extension 27 of the turbine 25, which causes the turbine to rotate, as shown in step 95. The rotation of the turbine 25 produces usable mechanical energy from the kinetic energy of the water, as shown in step 97. Step 97 diverges into two directions, step 99 and step 103. Step 103 indicates that the mechanical energy produced from the kinetic energy of the water can be stored, transferred, or used. Step 99 indicates that the water exits the first energy-converting module 11 and enters the second energy-converting module 11A and impinges upon the extensions 87 of the second turbine 85. The impinging water causes the turbine 85 to rotate, as shown in block 101. Step 101 diverges in two flows, step 103 and step 105. Step 103 indicates that the mechanical energy can be stored, transferred, or used. Step 105 indicates that the water is pumped out of the energy-converting apparatus 10A via a pumping system 50.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. For example, a plurality of energy-converting modules can be cascaded to various depths or be placed side by side. All such modifications and variations are intended to be included herein within the scope of this disclosure and the present invention and protected by the following claims.

Therefore, having thus described the invention, at least the following is claimed:

1. An energy-converting apparatus submerged in a body of water, where at least some of the water in the body of water is moving as a water current, comprising:
at least one energy converting module that is pressurized at a pre-determined internal pressure sufficient to offset the external pressure of the body of water in which the energy converting module is submerged, wherein the energy converting module includes at least one turbine, at least one exit port, and at least one intake system, wherein the intake system includes an entrance end and an exit end, the water flowing in the water current enters the entrance end of the intake system, wherein the water is accelerated as the water travels from the entrance end to the exit end of the intake system, wherein the exit end directs the accelerated water onto an extension of the turbine causing the turbine to rotate and produce mechanical energy, wherein the mechanical energy produced is derived from the kinetic energy of the water.

2. The apparatus of claim 1, further including a pumping module for pumping water out of the energy converting apparatus.

3. The apparatus of claim 1, further including means for converting mechanical energy into electrical energy.

4. The apparatus of claim 1, further including means for pumping water out of the energy converting apparatus.

5. An energy-converting apparatus submerged in a body of water, wherein at least some of the water is moving as a water current, comprising:
a first energy converting module that is pressurized at a first predetermined internal pressure sufficient to offset the external pressure of the body of water in which the first energy converting module is submerged, wherein the first energy converting module includes a first turbine, a first exit port, and a first intake system, wherein the intake system includes a first entrance end and a first exit end, the water flowing in the water current enters the first entrance end of the first intake system, wherein the water is accelerated as the water travels from the first entrance end to the first exit end of the first intake system and wherein the first exit end directs the water onto the first turbine causing the first turbine to rotate and produce mechanical energy; and
a second energy converting module that is pressurized at a second predetermined internal pressure sufficient to offset the external pressure of the body of water in which the second energy converting module is submerged, wherein the second energy converting module includes a second turbine, wherein the water from the first energy converting module exits the first energy converting module via the first exit port due to gravitation and enters the second energy converting module, and wherein the water impinges upon an extension of the turbine and causes the second turbine to rotate and produce mechanical energy.

6. The energy-converting apparatus of claim 5, wherein the second energy converting module includes an intake system wherein the intake system includes a second entrance end and a second exit end, the water flowing in the water current enters the second entrance end of the second intake system, wherein the water is accelerated as the water travels from the second entrance end to the second exit end of the second intake system and wherein the second exit end directs the water onto the second turbine causing the second turbine to rotate and produce mechanical energy.

7. The apparatus of claim 5, further including a pumping module for pumping water out of the energy converting apparatus.

8. The apparatus of claim 5, further including means for converting mechanical energy into electrical energy.

9. The apparatus of claim 5, further including means for pumping water out of the energy converting apparatus.

10. A method of converting water current energy into usable energy, comprising the steps of:
accepting water into a first intake system;
accelerating the water using the first intake system;
directing the water from the first intake system onto a first turbine causing the first turbine to rotate; and
producing mechanical energy.

11. The method of claim 10, further comprising the steps of:
directing the water onto a second turbine by allowing gravity to accelerate the water, wherein the water impinging upon the second turbine causes the second turbine to rotate; and
producing mechanical energy.

12. The method of claim 11, further comprising the steps of:
accepting water into a second intake system;
accelerating the water using the second intake system;
directing the water from the second intake system onto a second turbine causing the second turbine to rotate; and
producing mechanical energy.

13. The method of claim 10, further including:
means for pumping water.

14. The method of claim 10, further comprising the step of:
converting the mechanical energy into an alternative energy.

15. The method of claim 12, further comprising:
means for converting the mechanical energy into an alternative energy.
